(19) United States
(12) Patent Application Publication
(10) Pub. No.: US 2025/0124609 A1
(43) Pub. Date: Apr. 17, 2025

(54) METHOD FOR EFFECTIVELY EXHIBITING WORKS OF ART ON EXHIBITION SITES

(71) Applicant: HSIN-HUNG CHEN, Taichung City (TW)

(72) Inventor: HSIN-HUNG CHEN, Taichung City (TW)

(21) Appl. No.: 18/486,171

(22) Filed: Oct. 13, 2023

(51) Int. Cl. G06T 11/00; G06F 3/14; H04L 67/12

(52) U.S. Cl. CPC G06T 11/00; G06F 3/14; H04L 67/12

(57) ABSTRACT

Exhibiting devices, uploading devices and viewing devices are connected to a server. At least one of the uploading devices uploads at least one image of at least one work of art. At least one of the exhibiting devices to uploads at least one image of at least one exhibition site. The server integrates the image of the work of art with the image of the exhibition site. The server announces exhibition of the work of art on the exhibition site. At least one of the viewing devices searches for the exhibition. The server generates an electronic map to show the location of the exhibition. The server pushes an assignment about the exhibition. At least one of the viewing devices finishes the assignment. The exhibiting, uploading or viewing device reports the finishing of the assignment to the server. The server updates data and sends the updated data to the exhibiting devices, the uploading devices and the viewing devices.

### BACKGROUND OF INVENTION

### 1. FIELD OF INVENTION

The present invention relates to works of art and, more particularly, to a method for effectively exhibiting works of art on exhibition sites.

### 2. RELATED PRIOR ART

Works of art are results of cultural creation. For example, antiques, paintings, calligraphies, ink painting and sculptures are precious items worth careful collection. A collector may exhibit a work of art for educational and/or commercial purposes. Hence, museums, art galleries and schools hold exhibitions of works of art.

An artist or a collector borrows or rents a cultural center, a museum, an art gallery or a school to exhibit works of art. The exhibition is announced by posters, web pages, social-medium web sites, email, social networks of exhibiting units and/or artists' social networks. People are allowed to search for the exhibition and decide whether to see the exhibition or not after receiving a notice of reading an announcement. Messages for exhibitions are spread according to a database accessible for members only. The members may search for or just happen to find the exhibitions. The messages are often inadequate to lure the members to the exhibitions.

The present invention is therefore intended to obviate or at least alleviate the problems encountered in the prior art.

### SUMMARY OF INVENTION

It is an objective of the present invention to provide a method for effectively exhibiting works of art on exhibition sites by providing realistic images of works of art on exhibition sites.

It is another objective of the present invention to provide a method for effectively exhibiting works of art on exhibition sites by allowing viewers to interact with exhibiting sites or owners.

It is another objective of the present invention to provide a method for effectively exhibiting works of art on exhibition sites by providing incentives for viewers to interact with the exhibiting sites or owners.

To achieve the foregoing objectives, exhibiting devices, uploading devices and viewing devices are connected to a server. At least one of the uploading devices uploads at least one image of at least one work of art. At least one of the exhibiting devices to uploads at least one image of at least one exhibition site. The server integrates the image of the work of art with the image of the exhibition site. The server announces exhibition of the work of art on the exhibition site. At least one of the viewing devices searches for the exhibition. The server generates an electronic map to show the location of the exhibition. The server pushes an assignment about the exhibition. At least one of the viewing devices finishes the assignment. The exhibiting, uploading or viewing device reports the finishing of the assignment to the server. The server updates data and sends the updated data to the exhibiting devices, the uploading devices and the viewing devices.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a system for executing a method for effectively exhibiting works of art according to the preferred embodiment of the present invention;

FIG. 2 is a block diagram of the system shown in FIG. 1;

FIG. 3 is a flow chart of the method for effectively exhibiting works of art according to the preferred embodiment of the present invention;

FIG. 4 is an image of an exhibition site;

FIG. 5 is an image a work of art;

FIG. 6 is a synthetic image of the work of art shown in FIG. 5 on the exhibition site shown in FIG. 4;

FIG. 7 is a front view of a viewing device; and

FIG. 8 is a perspective view of a viewer using a viewing device to interact with an uploading or exhibiting device.

### DETAILED DESCRIPTION OF PREFERRED EMBODIMENT

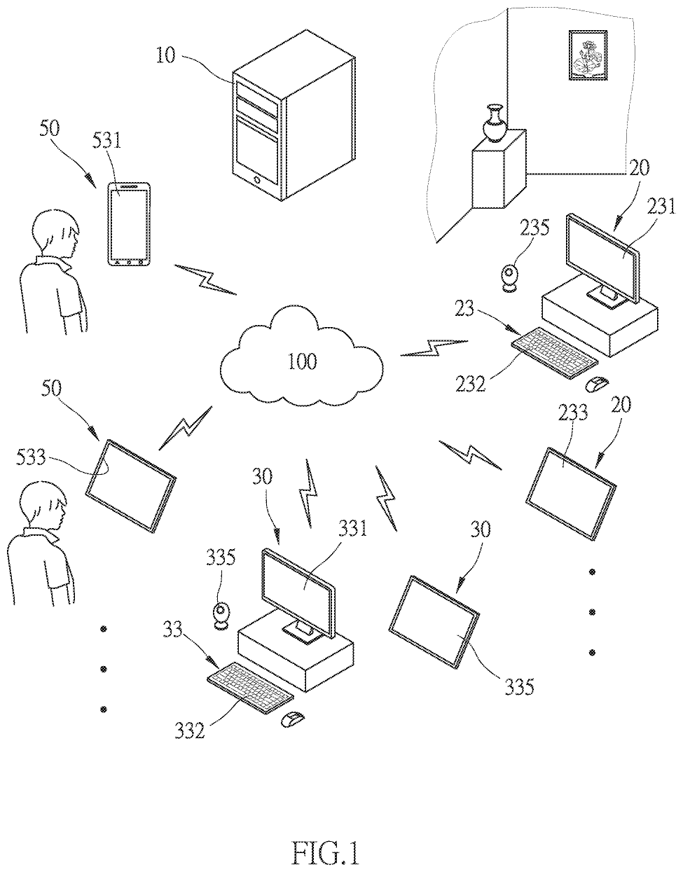

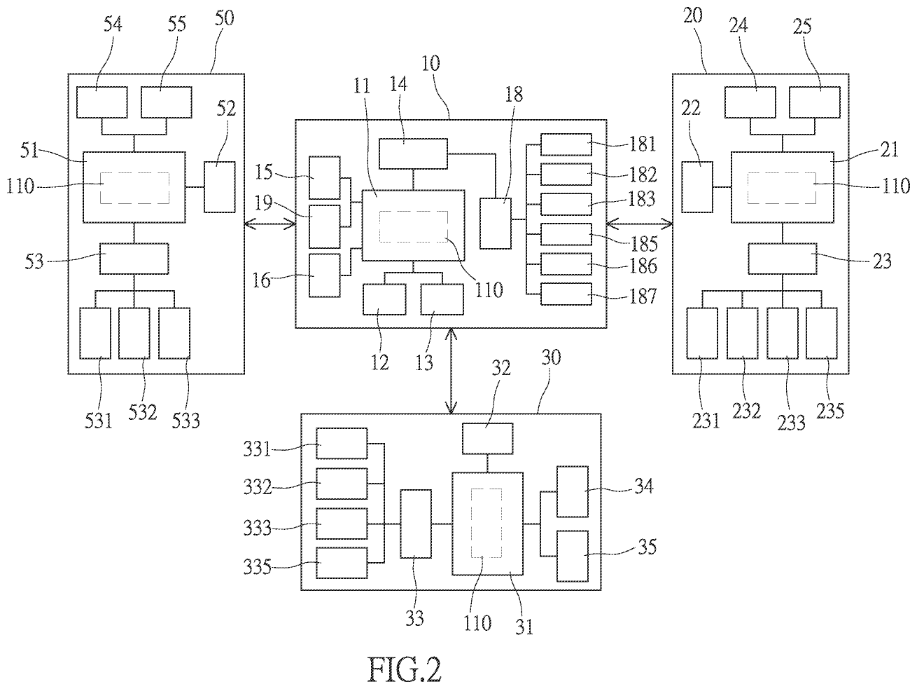

Referring to FIG. 1, according to the preferred embodiment of the present invention, a method for effectively exhibiting works of art on exhibition sites is executable by a system including a server 10, at least one exhibiting device 20, at least one uploading device 30 and at least one viewing device 50 connected to one another via the Internet 100 with wires or in a wireless manner. The server 10 is operated by a trade platform (a service provider) to transmit and receive commands and/or data to organize exhibitions. Each of the exhibiting devices 20 is operated by a provider of an exhibition site in cooperation with the trade platform. Each of the uploading devices 30 is operated by a provider of a work of art in cooperation with the trade platform. Each of the viewing devices 50 is operated by a viewer in communication with the trade platform.

The server 10 includes a processor module 11, a transceiver module 12, a memory module 13 and a storage module 14, an image-integrating module 15, a message-pushing module 16, a data module 18 and an electronic map generator 19.

The transceiver module 12 is connected to the processor module 11.

The memory unit 13 includes at least one random-access memory connected to the processor module 11.

The storage module 14 includes at least one hard disc drive connected to the processor module 11.

The image-integrating module 15 is connected to the processor module 11 and operable to provide synthetic or virtual-reality (“VR”) images. Each of the synthetic or VR images is made by integrating at least one image of at least one work of art with at least one image of at least one exhibition site.

The message-pushing module 16 is connected to the processor module 11 and operable to push events for exhibitions. An event for an exhibition includes but not limited to the location of at least one exhibition site, data about at least one work of art exhibited or to be exhibited, and at least one incentive for viewing such as credits, coupons and rewards in cash.

The data module 18 is built in the storage module 14. The data module 18 includes a member database 181, an exhibition-site database 182, a work-of-art image database 183, an image-integrating database 185, an exhibition message database 186 and an event-for-exhibition database 187. The member database 181 is operable to store data about members such as providers of works of art, providers of exhibition sites and views who join the trade platform. The data about the members include but not limited to basic identification, credits for viewing, data about exhibited works of art, and things to get or lose after conducting events of exhibition as set forth in advertisement pushed.

The exhibition-site database 182 is operable to store basic identification of exhibition sites and images of the exhibition sites. Each of the images of each of the exhibition sites shows a whole or portion of the exterior or interior of the exhibition site.

The work-of-art image database 183 is operable to store data about works of art. The data about each of the works of art include but not limited to basic identification data and at least one image of the work of art.

The image-integrating database 185 is operable to generate and store the synthetic or VR images of the works of art on the exhibition sites.

The exhibition message database 186 is operable to store data about exhibitions of works of art on exhibition sites. The data about the exhibition of a work of art on an exhibition site includes but not limited to the work of art exhibited or to be exhibited, at least one creator of the work of art exhibited or to be exhibited, the period of time of the exhibition, and the location of a related exhibition site.

The event-for-exhibition database 187 is operable to store data about events for exhibitions. The data about an event for an exhibition includes but not limited to at least one incentive for members who finish assignments.

The processor module 11 is operable to run an exhibition-managing program 110 stored in the storage module 14. The exhibition-managing program 110 includes a web-page application program run on a web site or a mobile application program built in the viewing devices 50, the uploading devices 30 and the exhibiting devices 20 for communication of data with the server 10. The exhibition-managing program 110 allows works of art to be exhibited, data about works of art and exhibition sites and conditions for pushing to be set, and members to search for works of art.

The electronic map generator 19 is connected to the processor module 11. The electronic map generator 19 is operable to generate an electronic map according to the locations of the exhibiting devices 20, the uploading devices 30 and the viewing devices 50. The electronic map can be shown on a home page handled by the exhibition-managing program 110 to help views use the viewing devices 50 to reach the exhibition sites.

Each of the exhibiting devices 20 is operated by a provider of an exhibition site. An exhibition site is cultural center, a professional exhibition hall, an art gallery or a school for example. Each of the exhibiting devices 20 includes a processor unit 21, a transceiver 22, an interface 23 and a sensor module 24. The processor unit 21 is operable to execute the exhibition-managing program 110.

The interface 23 is connected to the first processor unit 21. For example, the interface 23 includes a monitor 231, a keyboard 232 and/or a touch panel 233 operable by a provider of an exhibition site to check pages provided by the exhibition-managing program 110, to set terms and input data. The interface 23 preferably includes an image-taking device 235 operable to take real-scene images of the whole or a portion of the exterior or interior of the exhibition site.

The sensor module 24 is connected to the processor unit 21. For instance, the sensor module 24 includes an infrared transmitter, a high-frequency wireless communication element (NFC), a blue tooth transceiver, radio tag, a barcode scanner, a barcode or a barcode scanner for example. The sensor module 24 preferably includes multiple sensors arranged in various positions in and/or out of the exhibition site, on or in exhibited works of art. The sensor module 24 allows the provider of the exhibition site to interact with viewers who use the viewing devices 50 to view the exhibited works of art or read data about the exhibited works of art.

The processor unit 21 of the exhibiting device 20 is further connected to a locator module 25. The locator module 25 is a global positioning system (“GPS”) module. The locator module 25 is used with the exhibiting device 20 to mark the location of the exhibition site. The processor unit 21 of the exhibiting device 20 executes the exhibition-managing program 110 to upload real-scene images of the exhibition site, set, amend and register data about exhibitions, allow the provider of the exhibition site to interact with the viewers who use the viewing devices 50.

Each of the uploading devices 30 is used by a provider of a work of art. The provider of a work of art is an artist, an owner or a trustee (an exhibition unit) for example. Each of the uploading devices 30 includes a processor unit 31, a transceiver 32 and an interface 33. The processor 31 is operable to execute the exhibition-managing program 110.

The interface 33 is connected to the processor unit 31. For example, the interface 33 includes a monitor 331, a keyboard 332 and/or a touch panel 333 operable for a provider of a work of art to view web pages provided by the exhibition-managing program 110, set terms and input data. The interface 33 preferably includes an image-taking device 335 operable to take real-scene images of the work of art.

The processor unit 31 of the uploading device 30 executes the exhibition-managing program 110 to upload the real-scene images of the work of art, set, amend and register data about the work of art.

In another embodiment, the uploading device 30 is the exhibiting device 20, and the processor unit 31 of the uploading device 30 is connected to a sensor module 34. The sensor module 34 includes an infrared transceiver, a high-frequency wireless communication element (NFC), a blue tooth transceiver, a radio tag, a radio tag reader, a barcode or a barcode scanner for example. The sensor module 34 allows the provider of a work of art to interact with viewers who use the viewing devices 50 to view the exhibited works of art or read data about the exhibited works of art.

The processor unit 21 of the uploading device 30 is further connected to a locator module 35. The second locator module 35 is a GPS module for example. The locator module 35 is used with the uploading device 30 to mark the location of the exhibition site.

Each of the viewing devices 50 is a mobile device operable by a viewer for example. Each of the viewing devices 50 includes a processor unit 51, a transceiver 52, a interface 53, a sensor module 54 and a locator module 55. The processor 51 is operable to execute the exhibition-managing program 110.

The interface 53 is connected to the processor unit 51. The interface 53 includes a monitor 531, a keyboard 532 and/or a touch panel 533 operable by a provider of an exhibition site to view a web page provided by the exhibition-managing program 110, set terms and input data.

The sensor module 54 is connected to the processor unit 51. The sensor module 54 includes an infrared transceiver, a high-frequency wireless communication element (NFC), a blue tooth transceiver, a radio tag, a radio tag reader, a barcode or a barcode scanner. A viewer uses the third sensor module 54 to interact with a provider of an exhibition site who uses the exhibiting device 20 and/or a provider of a work of art who uses an uploading device 30.

The locator module 55 is connected to the processor unit 51. The processor unit 51 is a GPS module. The locator module 55 is operable to mark the location of a viewer. The processor unit 51 is operable to execute the exhibition-managing program 110 to allow a viewer to search for an exhibition site, input, set and amend message of exhibitions. The locator module 55 is used with the electronic map provided by the exhibition-managing program 110 to help a view reach the exhibition site. In an embodiment, the viewing device 50 can be a wearable device for virtual reality.

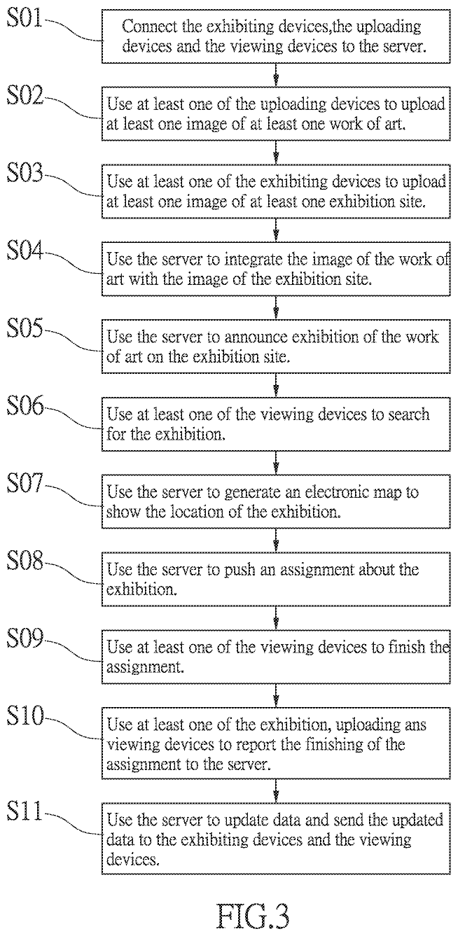

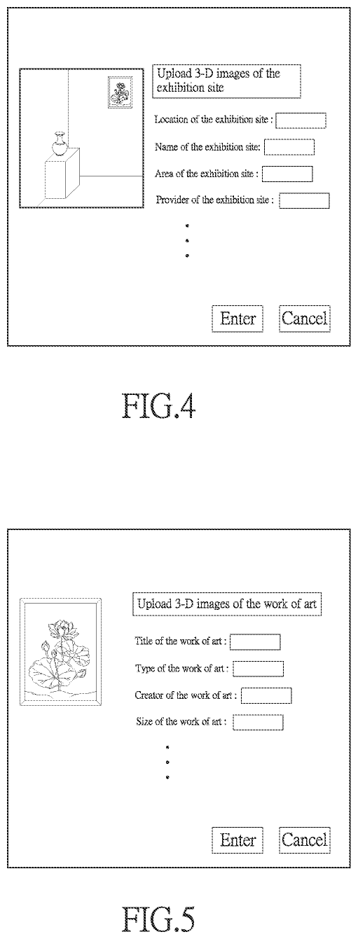

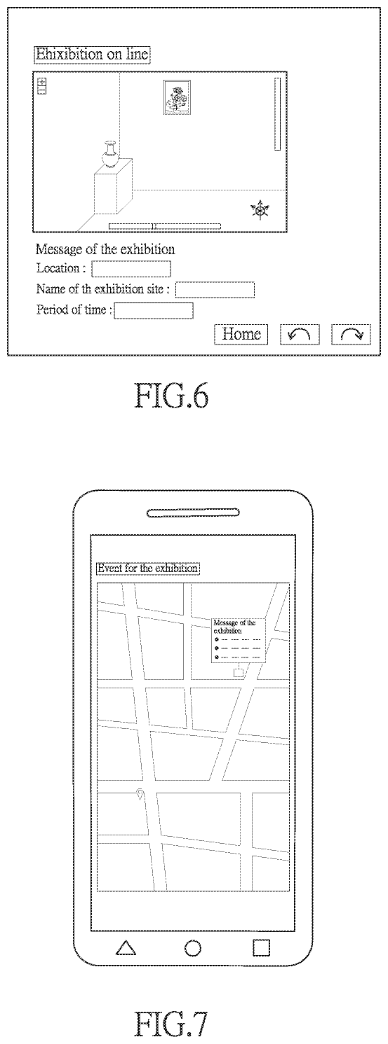

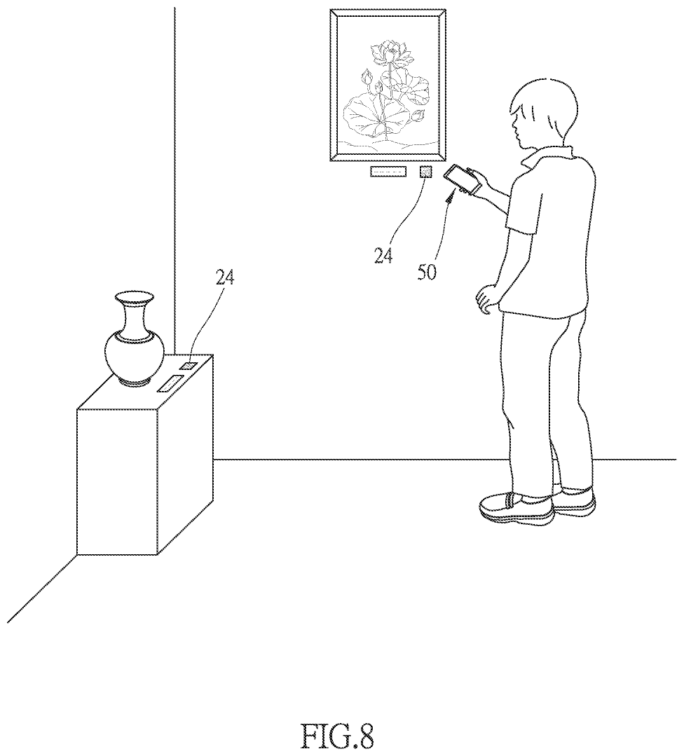

Referring to FIG. 3, the method for providing a synthetic image of a work of art in an exhibition site will be described. For briefness and clarity, the following description will be given to only one exhibiting device 20, only one uploading device 30 and a viewing device 50.

At S01, the exhibiting devices 20, the uploading devices 30 and the viewing devices 50 are connected to the server. In the beginning, the server 10, the exhibiting device 20, the uploading device 30 and the viewing device 50 are turned on. The exhibiting device 20, the uploading device 30 and the viewing device 50 are connected to the server 10 via the Internet 100. The exhibition-managing program 110 built in the server 10, the exhibiting device 20, the uploading device 30 and the viewing device 50 is turned on to allow the exhibition platform to communicate data with the members to register and/or log on the exhibiting device 20, the uploading device 30 and the viewing device 50. Data about the members are stored in the member database 181 of the data module 18 of the server 10.

At S02, at least one of the uploading devices 30 is used to upload at least one image of at least one work of art. The uploading device 30 is used to run the exhibition-managing program 110 to provide data about the work of art and the real-scene image of the work of art. The interface 33 connected to the processor unit 31 is used to upload the data about the work of art. The image-taking device 335 of the interface 33 is used to take the real-scene image of the work of art. The transceiver 32 of the uploading device 30 is used to transmit the data and real-scene image of the work of art to the work-of-art image database 183 of the data module 18 of the server 10. In another embodiment, the exhibiting device 20 is used to upload the data and real-scene image of a work of art.

At S03, at least one of the exhibiting devices 20 is used to upload at least one image of at least one exhibition site. The interface 23 connected to the processor unit 21 is used to run the exhibition-managing program 110 to upload the data and real-scene images of the exhibition site. The image-taking device 235 of the interface 23 is used to take the real-scene image of the exhibition site. The transceiver 22 is used to transfer the data and images of the exhibition site to the exhibition-site database 182 of the data module 18 of the server 10.

At S04, the server 10 is used to integrate the image of the work of art with the image of the exhibition site. Thus, a synthetic image of the work of art on the exhibition site is generated. In detail, the server 10 receives the real-scene image of the work of art from the uploading device 30, receives the real-scene image of the exhibition site from the exhibiting device 20. The image-integrating module 15 of the processor module 12 of the server 10 generates a synthetic image of the work of art on the exhibition site by integrating the real-scene image of the work of art with the real-scene image of the exhibition site. The synthetic image is stored in the image-integrating database 185 of the data module 18. In an embodiment, real-scene image of the work of art is integrated with the real-scene image of the exhibition site to generate a VR image to be stored in the image-integrating database 185 so that wearable device can be used to view the VR image.

At S05, the server 10 is used to announce exhibition of the work of art on the exhibition site. The exhibiting device 20 or the uploading device 30 runs the exhibition-managing program 110 to transfer a message of the exhibition of the work of art to the server 10. Then, the server 10 runs the exhibition-managing program 110 to announce the message of the exhibition of the work of art. The image-integrating database 185 of the data module 18 of the server 10 provides the synthetic image or the VR image to be viewed by the viewing device 50 on line. The message of the exhibition can be posted on a web page provided by the exhibition-managing program 110, posted on social media, sent by email, shown by an exhibition unit or spread in groups in social application programs.

At S06, at least one of the viewing devices 50 is used to search for the exhibition. The viewing device 50 is used to search for the exhibition. In an embodiment, the viewing device 50 receives a notification of the exhibition. The exhibition-managing program 110 is executed to set a type or a creator of works of art, an exhibition site or a point of time for example to search for the message of the exhibition in the server 10. The viewing device 50 is used to run the exhibition-managing program 110 to view the synthetic image or the VR image on line. The viewing device 50 is operable to obtain the address of the exhibition site to render on-site viewing possible.

At S07, the server 10 is used to generate an electronic map to show the location of the exhibition. The exhibition-managing program 110 of the server 10 is operable to use the location unit 25 of the exhibiting device 20, the location unit 35 of the uploading device 30 and the location unit 55 of the viewing device 50 to allow the electronic map generator 19 connected to the processor module 11 to generate an electronic map. The electronic map shows the location of the viewing device 50, the location of the exhibiting device 20 and the location of the uploading device. The viewing device 50 runs the exhibition-managing program 110 to show the electronic map so that near-by exhibition sites or works of art can be searched for and/or a viewer can be guided to the exhibition sites or works of art.

At S08, the server is used to push an assignment about the exhibition. The server 10 runs the exhibition-managing program 110 to process the preferences, location, anniversaries and/or holidays stored in the data module 18, and the data about the exhibition from the exhibiting device 20 and/or the uploading device 30. After the viewing device 50 receives the data about the location, the server 10 uses the message-pushing module 16 to send an assignment including the data of the location and the message of the exhibition. The assignment includes but not limited to the location of the exhibition site, the location of the work of art, a task such as scanning a barcode or having a barcode scanned, and an incentive such as credits, coupons and rewards in cash.

At S09, at least one of the viewing devices 50 is used to finish the assignment. The location module 55 of the viewing device 50 follows the electronic map provided by the exhibition-managing program 110 to guide the viewing device 50 to the location of the exhibition site or work of art. Then, the viewing device 50 is used to interact with the exhibiting device 20, the uploading device 30 or the server 10 as assigned in the assignment. For example, the sensor module 54 of the viewing device 50 is used to scan the sensor module 24 of the exhibiting device 20 or the sensor module 34 of the uploading device 30.

At S10, at least one of the exhibiting, uploading and viewing devices 20, 30 and 50 is used to report the finishing of the assignment to the server 10. After the viewing device 50 interacts with the exhibiting device 20 or the uploading device 30, the viewing device 50, the exhibiting device 20 and/or the uploading device 30 report the completion of the assignment to the server 10. The server 10 runs the exhibition-managing program 110 to integrate, analyze and manage of the reports, updates the data in the member database 181 of the data module 18, and stores the updated data in the event-for-exhibition database 187 of the data module 18 of the server 10.

At S11, the server 10 is used to update data and send the updated data to the exhibiting devices 20, the uploading devices 30 and the viewing devices 50. After the data in the data module 18 of the server 10 are updated, the updated data are sent to and shown on the viewing device 50, the exhibiting device 20 or the uploading device 30 based on the requests from the viewing device 50, the exhibiting device 20 and the uploading device 30 or discretion of the server 10. Thus, the viewing device 50 is allowed to claim the incentive from the exhibiting device 20 or the uploading device 30. The claim of the incentive is reported to the server 10 to allow the exhibition-managing program 110 to update the data to reduce or delete credits, coupons and incentives to be claimed by the viewing device 50.

As discussed above, the image-integrating module 15 of the server 10 integrates the real-scene image of the work of art with the real-scene image of the exhibition site to provide a synthetic image of the work of art on the exhibition site. The message of the exhibition is posted to allow the viewing device 50 to be used to view the work of art. The message-pushing module 16 of the server 10 is used to push the assignment to the viewing device 50 if so desired. Thus, the viewing device 50 can be used to interact with the exhibiting device 20 or the uploading device 30 as assigned in the assignment. Thus, the efficiency of the promotion of the exhibition is increased. Moreover, the server 10 is allowed to initiatively post the assignment, thereby allowing a small exhibition site, a society or a school to attract a lot of attention to the exhibit of a work of art without having to spend a large amount of money on advertisement and/or marketing. That is, the exhibition of the work of art is successfully exposed at a low cost. Hence, the exhibition of the work of art is inexpensive and successful educationally and commercially.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims. CLAIMS

1. A method for effectively exhibiting works of art on exhibition sites comprising the following steps of:
providing a server;
providing exhibiting devices;
providing uploading devices;
providing viewing devices;
connecting the exhibiting devices, the uploading devices and the viewing devices to the server;
using at least one of the uploading devices to upload at least one image of at least one work of art;
using at least one of the exhibiting devices to upload at least one image of at least one exhibition site;
using the server to integrate the image of the work of art with the image of the exhibition site;
using the server to announce exhibition of the work of art on the exhibition site;
using at least one of the viewing devices to search for the exhibition;
using the server to generate an electronic map to show the location of the exhibition;
using the server to push an assignment about the exhibition;
using at least one of the viewing devices to finish the assignment;
using at least one of the exhibiting, uploading and viewing devices to report the finishing of the assignment to the server; and
using the server to update data and send the updated data to the exhibiting devices, the uploading devices and the viewing devices.

2. The method according to claim 1, wherein the step of using the server to integrate the image of the work of art with the image of the exhibition site comprises the step of providing a virtual-reality image to be viewed with a wearable device.

3. The method according to claim 1, comprising the step of using the server to generate an electronic map to show the location of the exhibition after the step of using at least one of the viewing devices to search for the exhibition.

4. The method according to claim 1, wherein the viewing device is a wearable device for virtual reality, the server is used to provide a virtual-reality image from the image of the work of art and the image of the exhibition site.

5. The method according to claim 1, comprising the step of executing an exhibition-managing program in the server, the exhibiting devices, the uploading devices and the viewing devices.

6. The method according to claim 5, whereon the exhibition-managing program is a mobile application program.

7. The method according to claim 1, wherein each of the exhibiting, uploading and viewing devices comprises an interface.

8. The method according to claim 1, wherein each of the exhibiting devices comprises an image-taking device operable to take at least one image of at least a portion of at least one of exterior and interior of the exhibition site.

9. The method according to claim 1, wherein each of the exhibiting devices comprises a locator module operable to provide location of at least one exhibition site, wherein each of the uploading devices comprises a locator module operable to provide location of at least one work of art.

10. The method according to claim 1, wherein each of the uploading devices comprises:
a locator module operable to provide location of at least one work of art; and
a sensor module operable to interact with the viewing devices.
